(19) United States
(12) Patent Application Publication
(10) Pub. No.: US 2003/0195780 A1
(43) Pub. Date: Oct. 16, 2003

(54) Computer-based optimization system for financial performance management

(75) Inventors: Arti Arora, Cupertino, CA (US); Edward Lazear, Portola Valley, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Liquid Engines, Inc., Sunnyvale, CA (US)

(21) Appl. No.: 10/319,182

(22) Filed: Dec. 13, 2002

Related U.S. Application Data
(60) Provisional application No. 60/341,129, filed on Dec. 13, 2001.

(51) Int. Cl. G06F 17/60

(52) U.S. Cl. 705/7

(57) ABSTRACT

A system for analyzing and optimizing allocation of factors among different business entities. The analysis, or optimization, can be targeted to a specific business financials measurement, or metric. Many different types of factors can be considered regardless of their initial definition, description or form. For example, along with revenues, profit, inventory size, etc., human characteristics such as incentive and performance can be measured and optimized. A preferred embodiment of the invention concerns analyzing factor allocation to reduce overall taxes for a company with subsidiaries in regions with different tax laws. The system includes consideration of local, state, federal and international taxes, transfer pricing, tax credit limitations, inter-state allocations in unitary and non unitary environments, carry-overs, and others. The system preferably uses a versatile matching engine, described herein, to automate the analysis and optimization. The matching engine is capable of discrete and continuous attribute value weighting, and of performing substitution of attributes, or other variables.

### COPYRIGHT NOTICE

A portion of the disclosure recited in the specification contains material that is subject to copyright protection. Specifically, documents provided with this application include source code instructions for a process by which the present invention is practiced in a computer system, included as a computer program listing appendix on a CDROM accompanying this application in accordance with 37 CFR Section 1.96. The copyright owner has no objection to the facsimile reproduction of the specification as filed in the Patent and Trademark Office. Otherwise, all copyright rights are reserved.

### BACKGROUND OF THE INVENTION

This invention relates in general to digital processing and more specifically to a system for analyzing allocation of factors relevant to business operations.

Maximizing financial performance is critical for businesses. However, this goal requires understanding complex interactions and tradeoffs that result from allocation of factors, such as cost and revenues, within a business. Businesses that have different geographic locations are subjected to different laws in different locations. Laws are often highly detailed and can implicate many characteristics of business operation such as transfer and handling of goods, tariffs, taxes, environmental effects, securities-related actions, management actions, compensation, and others. Even within a single legal jurisdiction, different laws and regulations may come into play to affect financial performance depending on the company's actions.

Other considerations, such as time-to-market, inventory, insurance, management motivation, bookkeeping, public reporting, etc., can intertwine with legal concerns in making a business decision. For example, a company with subsidiaries in California and Nevada can incur costs due to shared operations. The costs can be allocated, in varying degree, to either the California or Nevada subsidiary. In deciding how much cost to allocate a manager might realize tax advantages in California. However, another concern is that Nevada operational managers will have little incentive to conserve on costs if a large portion of the costs are being assigned to the California subsidiary.

This example suggests that some sort of a tradeoff analysis would be helpful in order to optimize business operations. However, such analysis is difficult a single financial measure such as tax. The incentive aspect requires measuring motivation and performance in such a way that the measurements can be compared or computed with tax benefit. Such measurements are difficult to obtain and use in a meaningful way with other financial data. Also, other factors may be involved that further complicate analysis beyond any reasonable solution, such as regulatory, intra-company conflicts and external business considerations.

Traditionally, business financial decisions are made with piecemeal analysis. Statistics and reports might be used to provide some indication of an action's outcome. However, such reports are backward-looking as they are based on data of past performance. and can require approximation and guesswork to achieve an unreliable projection. Often the tools that are used by today's managers do not provide detailed and current calculations for financial performance measures, or other fast-changing aspects of business. For large companies with a presence in many regions, analysis of even one factor can be confounding due to the many different regulatory laws.

What is needed is a system and method that provides visibility and control of financial allocation that can be applied in a uniform manner across a global enterprise. What is further needed is a system and method that enables the identification and optimization of financial decisions that takes into account incentives, tax considerations and other measures of financial performance.

### SUMMARY OF THE INVENTION

The present invention provides a computer-based system and method for analyzing and optimizing the allocation of factors among different business entities optimizing the structuring of divisions or operations that roll up to business entities, or optimizing the structuring of entities themselves. More specifically, the system and method provide identification and optimization of financial decisions for global enterprises operating in many business jurisdictions. Advantageously, the system and method provides a model that identifies sub-optimal business and incentive conditions, automates iterative model building and calculates optimal scenarios. Designed for enterprise-wide Web deployment, the system and method enable tax, finance, treasury, and business unit managers to access a common set of models to evaluate the overall enterprise-wide tax impact of critical business decisions, including entity restructuring, mergers, acquisitions and business condition changes. Users can create or select a variety of methods by which to measure success and then optimize based on those metrics such as tax liability, earnings per share or cash flow.

The system performs optimization, analysis, and recommendation at any corporate node, whether geographical, divisional or by product line. The result is a corporate-wide visibility to all financial data impacting the performance of each business unit allowing the restructuring of transactions to enhance organization performance. The system operates on a core document that provides a 360 degree financial record containing both explicit and implicit agreements of various parties to make decisions and to receive cash flows in differing circumstances. Specifically, tax-related cash flows specified in these contracts can optimize prices at which internal assets are traded. These cash flows affect the ways in which objectives and incentives are organized by business units.

The analysis, or optimization, can be targeted to a specific business financials measurements or metrics. Many different types of factors can be considered regardless of the initial definition, description or form. For example, along with revenues, profit, inventory size, etc., human characteristics such as incentive and performance can be measured and optimized.

The system preferably uses a versatile matching engine, described herein, to automate the analysis and optimization. The matching engine is capable of discrete and continuous attribute value weighting, and of performing substitution of attributes, or other variables. The engine may couple a hedonic approach with linear and non-linear programming methods to obtain solutions to the optimization problem. The basic premise of the hedonic engine values environmental amenities that affect the other factors employed by the engine. However, many types of automated approaches can be used, such as suitably programmed general computer systems, or other combinations of hardware and software.

A preferred embodiment of the invention includes optimizing factor allocation to reduce overall taxes for a company with subsidiaries in regions with different regulations. The system includes consideration of local, state, federal and international taxes, transfer pricing, tax credit limitations, inter-state allocations in unitary and non-unitary environments, inter-national allocations, carryovers, and others.

In a typical embodiment, there are at least two ways to assign financial factors. The first is to assign factors, such as costs, to business entities, such as subsidiaries directly in order to maximize some objective function. An example is the assignment of costs to subsidiaries directly to minimize the tax bill (or maximize the negative value of the tax bill). After this is done, the solution can be combined in a linear or non-linear fashion with the output of maximizing another objective function, e.g., the best provision of incentives, to get a final allocation of factors, in this case costs.

The second method allows the engine to compute weights and assign them to drivers that then allocate the financial factors. For example, wage bill, square footage, and sales of each subsidiary may be defined as drivers. The optimization engine described in the previous paragraph is then used to calculate optimal weights for each of the drivers so as to maximize an objective function. Now, weights are the output of the problem and they can be combined with weights obtained from the maximization of another objective function in a linear or non-linear way. The weights are then multiplied by the value of the drivers for each of the various subsidiaries to obtain actual allocations of the factors.

One embodiment of the invention provides a method for assigning a financial factor to one of a plurality of business entities. The method includes steps of: identifying a factor to be assigned; indicating a metric to be optimized; defining one or more rules to be used in a optimization process; using a computer system to perform a step of comparing degrees of optimization of the metric based on assignment of the factor to different ones of the plurality of business entities, wherein the one or more rules are used to derive the degrees of optimization; and using the result of the comparing step to assign the financial factor to the one of a plurality of business entities.

Another embodiment of the invention provides a method including using a computer system to provide projected tax liability when business entity structures are combined, split or transferred, supported by internal management functions and external regulatory requirements.

Another embodiment provides a method for identifying a set of inter-company transactions between business entities and optimizing the transfer prices for the goods and services that flow between these entities to meet both business purpose as well as the effect on selected metrics such as tax liability or cash flow.

Another embodiment of the invention provides a method including allocating on of cost or revenue among a plurality of business entities; using a computer system to provide projected tax liability based on the allocations; and using the computer system to provide incentive determination based on the allocations made in the step of allocating.

Another embodiment of the invention provides a method including allocating one of cost or revenue among a plurality of business entities; using a computer system to provide projected tax liability based on the allocations; and using the computer system to provide an risk assessment projection based on the allocations made in the step of allocating.

### BRIEF DESCRIPTION OF THE DRAWINGS

FIG. 1 is a diagram illustrating basic components of a system to analyze and optimize financial performance

FIG. 2 illustrates the scalable, system design;

FIG. 3 illustrates a screen image of a list of scenarios;

FIG. 4 illustrates a screen image of a legal entity;

FIG. 5 illustrates a screen image of a partial UBG input page;

FIG. 6 illustrates a screen image of apportionment percentages;

FIG. 7 illustrates a screen image of a “what-if” scenario for a new distribution center;

FIG. 8 illustrates a screen image of a tax rule defined in a scenario to build a tax model.;

FIG. 9 illustrates a screen image of an optimization result; and

FIG. 10 illustrates a screen shot of a report wizard.

### DESCRIPTION OF THE SPECIFIC EMBODIMENTS

In the following description of a preferred embodiment, reference is made to the accompanying drawings, which form a part hereof, in which is shown by way of illustration specific embodiment in which the invention may be practiced. In the following description, numerous specific details are set forth in order to provide a complete understanding of the present invention. It will be apparent to one skilled in the art that the present invention may be practiced without the specific details. In the development of the actual implementation, numerous implementation-specific decisions must be made to achieve the design goals that will vary for each implementation. Accordingly, in order not to obscure the present invention, well-known structures and techniques are not shown or discussed in detail.

Business structuring, financial allocation and transaction pricing iare issues of strategic importance to global companies because they impact corporate and business-unit incentives and financial metrics like growth, profitability, effective tax rates and return-on-assets (ROA). Increasingly, global companies have recognized the need for more company-wide visibility on its forecasted cash flows. These flows are controlled by revenues, expense and capital decisions that are shared across geographic and political boundaries and need to be allocated across business units with respect to tax laws and generally accepted accounting principles (GAAP) methods.

In a preferred embodiment, the system employs a scenario-based approach that allows multi-year financial performance planning and analysis across all corporate entities, with results that can be easily shared between users in strategic business units, finance, treasury, and tax departments. The system finds optimal scenarios among all possible combinations for complex planning tasks such as entity restructuring, and presents the top options to the user for further planning actions.

With the present invention, users can evaluate proposed planning scenarios and pending legislation strategies and create unlimited “what-if” planning scenarios across multiple time periods, starting with specific facts and circumstances. Users can also quantify financial metrics using the calculation engine based on actual and forecasted transaction data from enterprise source systems. Optimization of entity structures, allocations and transaction pricing allows the user to measure metrics such as tax liability over time. Advantageously, users can collaborate with analysts and planners in departments for tax compliance, finance, treasury, and business units. Users can also document and monitor any plans created during analysis stages to support stringent requirements for legal consistency, planning decision transparency, business reporting, and audit tracking.

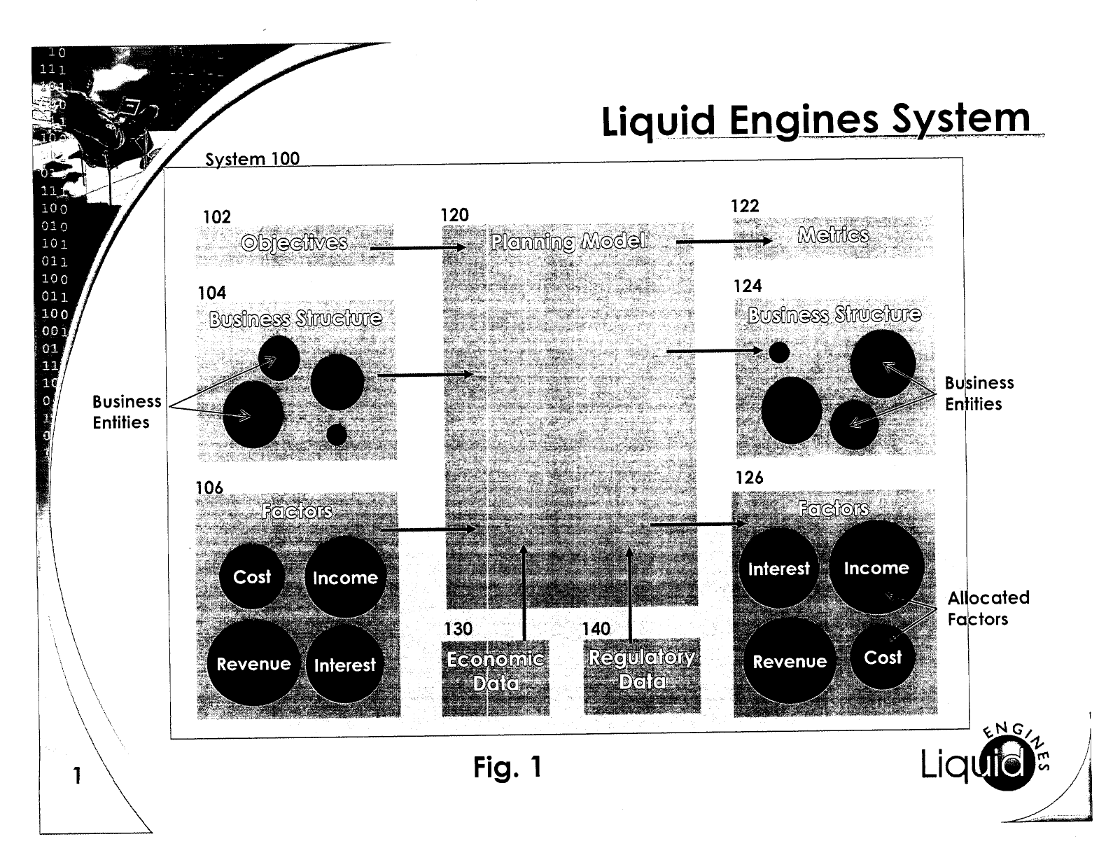

In FIG. 1, System 100 creates a model based on planning objectives 102, and an organization's legal, management and financial structure 104. It accepts factors 106 such as cost, revenue, income and interest, as well as transaction pricing as data inputs.

In FIG. 1, the system planning model 120 is used to analyze factor allocations, business entity structures and transaction pricing developed within the framework of external constraints, such as economic (130) and regulatory (140) feeds.

The system planning model uses objectives 102 to quantify and compare strategies. Business objectives may include aligning legal entity structures closely with management structures, resolving internal conflicts arising from inefficient operations or misaligned incentives, responding to external business, economic or regulatory changes, and/or reducing audit risk exposure from particular legal structures which are no longer defensible. Financial performance objectives for tax liability, cash flow, EPS, return on assets, and profitability may also be included as part of the objectives setting.

In FIG. 1, business entities are represented by circles within box 104. Business entities can be any division, subsidiary, partnership, company, affiliate, member that is related to a business operation. The business entities need not all be within a same legal framework. In other words, it is possible for the system to be used in an analysis where factors are allocated among separate companies. Business entities can also simply be groups of people, corporations, or other physically, conceptually or legally defined entities that are involved with a business operation being analyzed by the system of the present invention. In a preferred embodiment, the user can define business entities to suit particular types of analysis and optimization. Default groups of entities can exist in the form of templates, or other pre-defined collections. Not all of the business entities need have a factor allocated for accurate analysis and optimization to be achieved.

In a preferred embodiment, factors 106 are allocated among business entities. The factor allocation process can also be automated so that a computer system is used to, e.g., try different allocations to create a spectrum of predicted results. For example, visual graphs, maps, tables, etc., can be presented after many variations to a factor have been automatically performed. Such data can assist a human user to modify the factor, or other factors, to perform further analysis. As discussed below, automated allocation is also used when a human user directs the system to maximize, or optimize, specific metrics. Combinations of manual and automated allocation can be employed.

Note that other embodiments can accept other factors in addition to, or in place of, the factors mentioned. For example, sales regions, parts, or other resources necessary in creating a product or providing a service can also be “factors” allocated among subsidiaries or other business entities. In general, the system of the present invention is applicable to any tangible or intangible item, asset, service, agreement, instrument, resource or other characteristic of business operation that can be allocated among business entities. Factors can be of different types and can have sub-categories. Factors can also be defined by a human user in relation to existing factors, values, metrics (discussed below), etc., or factors can be entered as new factors by suitably defining the factors. For example, where the optimization engine described in the accompanying document is employed, factors can be defined as attribute/value pairs in mathematical, logical or relational equations, functions or algorithms.

In a preferred embodiment, the planning model 120 utilizes a specialized “matching or optimization engine” is used to perform the analysis. The matching engine component s described in pending U.S. patent application Ser. No. 09/823,955, filed Mar. 30, 2001 entitled “ELECTRONIC MATCHING ENGINE FOR MATCHING DESIRED CHARACTERISTICS WITH ITEM ATTRIBUTES” which is assigned to the assignee of the present invention, the disclosure of which is incorporated herein by reference for all purposes.

The optimization component complements the engine by using sophisticated mathematical techniques to solve very complex maximization problems. In the preferred embodiment, the optimization engine can calculate optimal entity structures, optimal transfer prices, and optimal allocation rules from a set of often almost uncountable possibilities. Using the optimization method, it is possible to avoid trial-and-error brute force approaches that may not get near the best solution.

The optimization-matching engine is well-suited to the type of analysis at issue in the present system. The engine is capable of discrete and continuous attribute value weighting, and of performing substitution of attributes, or other variables. The engine may couple a hedonic approach (valuation of environmental amenities that affect the other factors) with linear and non-linear programming methods to obtain solutions to the optimization problem. The engine includes variable weighting of attribute values. The weighting can be discrete or continuous. The engine can also selectively perform substitution for attributes, or other variables. These properties of the optimization-matching engine allow disparate types of values (e.g., money values and human performance measurements) to be manipulated and compared in meaningful ways without creating an undue processing burden. Although the present invention is discussed primarily in connection with the optimization-matching engine, it is possible to achieve, or use, aspects of the invention with other computing approaches.

The analysis process uses rules, or operations, describing a business' operating characteristics. These rules include internal data and external economic 130 and regulatory 140 feeds. Economic 130 can provide, for example, currency fluctuations and interest rate changes affecting dividend repatriations among multi-national entities. Regulatory 140 can provide, for example, rules for deriving tax implications of business operation. A preferred embodiment of the present invention is being developed by Liquid Engines, Inc., as computer software referred to as the “Financial Performance System.”

Outputs of the planning model 120 consist of: computations of resulting financial metrics 122, new business entity structures 124, and revised factors 126 (financial allocations and transaction pricing).

In the preferred embodiment, financial metrics are quantitative measures of the goals described by planning objectives. For instance, a business purpose metric (also referred to as risk assessment) is a measure of the probability of a business entity (or group of entities) complying with legal and business requirements coupled with the expected cost associated with a particular audit. The measure can be based on statistics obtained from records of actual audit frequency for different business practices or from subjective assessments by experts. The metric can include probability of reversal of an allocation and costs associated with an audit and reversal. The costs can include, but are not limited to, payback, penalties, interest and associated legal and accounting fees. The optimized solution can report risk assessment and expected cost of a reversal in addition to calculating the optimal revenue and cost allocation strategy.

These metrics can be reviewed at summary level, and at various levels of details through a drill down process available in the system. New business entities can be evaluated along legal, management or financial structures. Factors such as revenues, expense, income and transaction pricing are re-evaluated and automatically computed under the resulting business entity structure. All of these outputs provide visibility as assumptions and inputs for iteratively building scenario variations or even new scenarios as part of the financial performance management process.

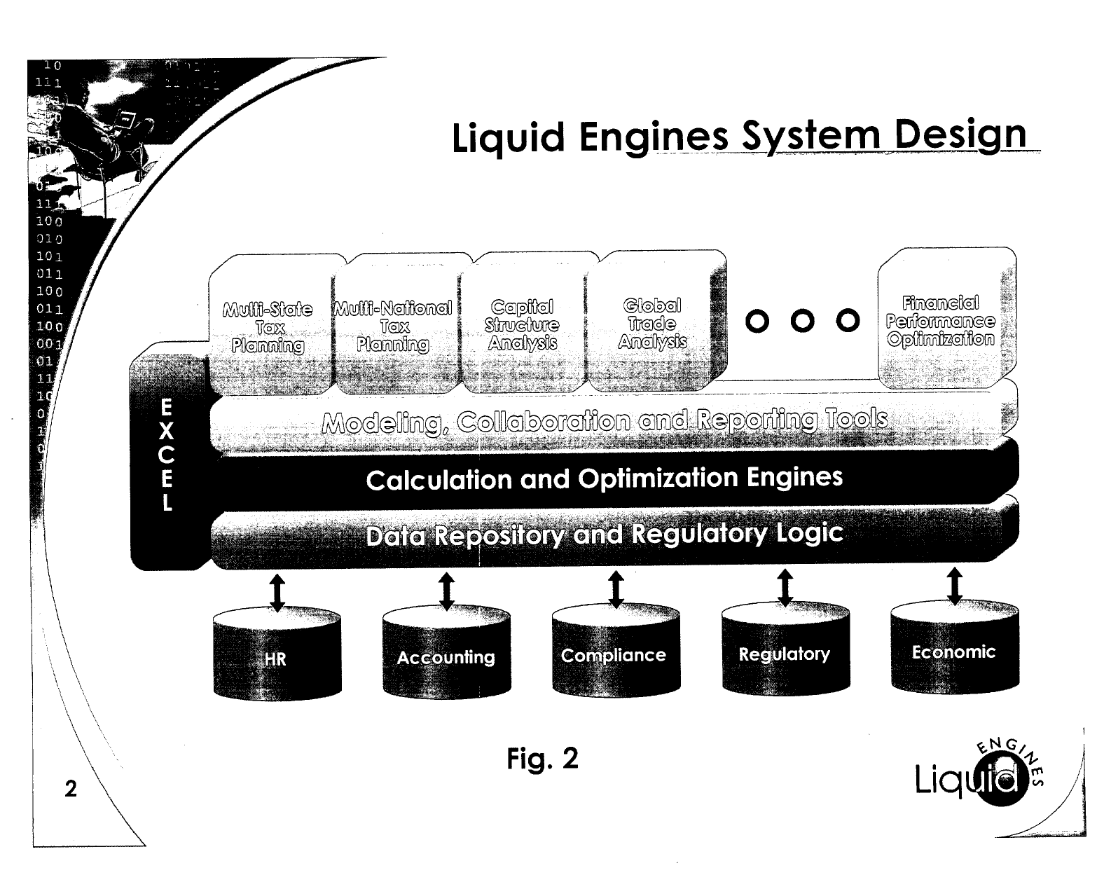

FIG. 2 illustrates the scalable design and nature of the present invention. In FIG. 2, a plurality of modules 202, 204, 206, 208 through 210 interface directly with the application layer 220, consisting of modeling, collaboration and reporting tools. Factors are electronically obtained from a plurality of databases 242-250 and input to the data repository 240. The business logic layer 230 has the rules, algorithms and engines for both ‘what if’ calculation and ‘what's best’ optimization. Along all three system layers (application, business logic engines and data repository), is a bi-directional interface to Microsoft Excel, a financial planners defacto desktop tool.

For data level examples, HR database 242 may contain information regarding organizational design, variable compensation incentives and corporate compensation plans. Regulatory database 248 may contain jurisdiction tax laws, rates governing tax calculations and case law interpretations. The economic database 250 may contain data such as GDP, government and corporate interest rates, and other economic modeling information specific to the finance (cost allocations, fixed asset management, budgeting) and treasury functions (capital structures, dividend repatriation, debt and equity financing) of the entity. Accounting database 244 may contain information for financial accounting, such as revenues, costs, income and fixed asset information. Compliance database 246 houses the as filed positions and reports to regulatory agencies. An Excel database 260 may include spreadsheets and other information for planning or performance. A breakthrough of the system design uses unique approach to create complete and stable planning models using only essential data elements. All of this data is assembled in a logical data model and scalable structure in the data repository 240.

Within the business logic layer 230, an example of the calculation engine is as follows: HR, accounting, compliance and regulatory data pertaining to a legal structure flows through this engine to compute tax liability for all entities within that structure. An optimization engine example is described where economic data, in addition to HR, accounting, compliance and regulatory data, is analyzed to create an optimal legal structure that balance business purpose with tax liability.,

The application layer 220, including its modules 202-210, is the user(s) interface to perform planning tasks and processes. An example of a end-to-end process is as follows: The Multi-State Tax Planning module can be used to identify business objectives, review current operational and legal structures, and analyze and quantify changes such as splitting a legal entity into various operations within the scenario framework. This module can also be used to test variations on this scenario, share its results across business functions, capture feedback and monitor ongoing effectiveness of the scenario. Additionally, scenario reports can be used to document business purpose that can be used for external audit support.

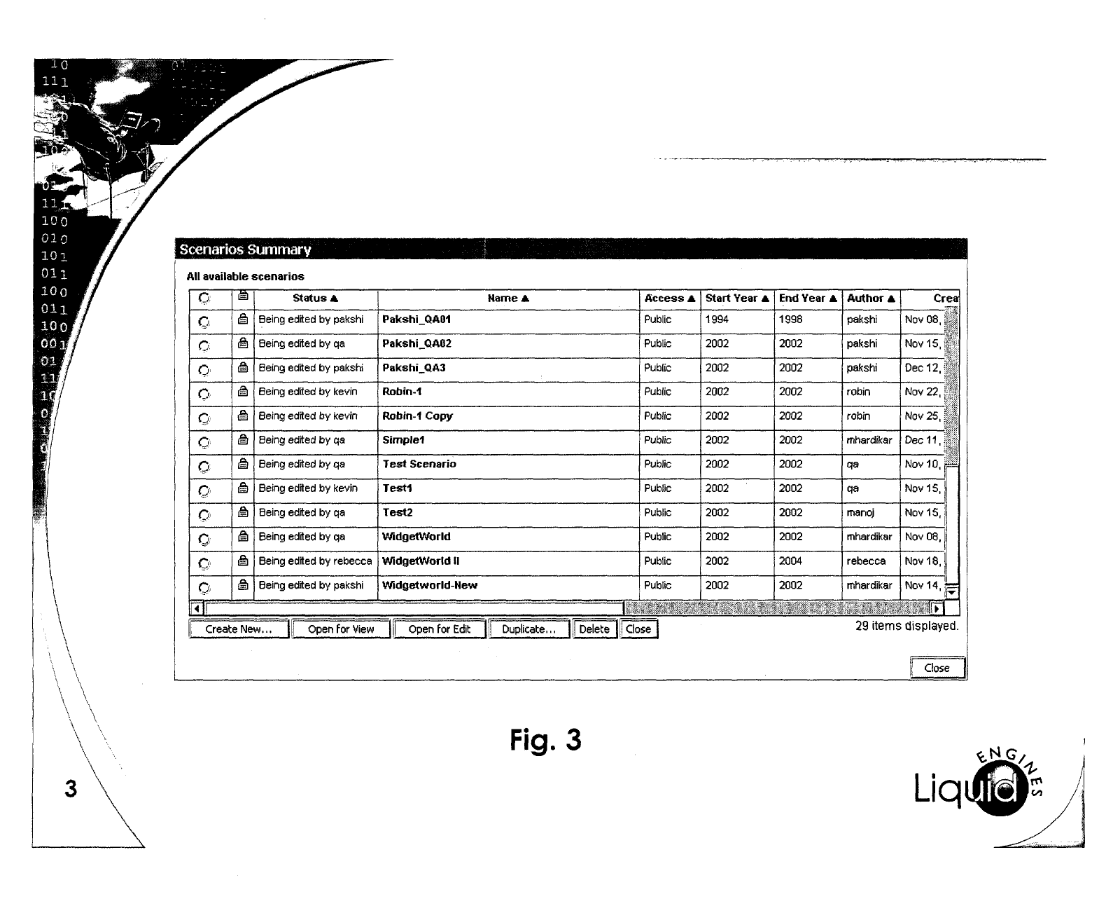

In operation, system 100 handles various data elements that comprise a scenario. A list of scenarios is illustrated in FIG. 3. “Data elements” describes things like legal entities, tax rules, and jurisdictions that are to be modeled. The flexible data model allows for entities and tax reporting structures to be independently modeled. Each data model includes data elements comprising data objects having associated attributes and values. Examples of data objects include legal entities, jurisdictions, and tax rules. An “instance” is a particular occurrence of a data object, which is distinct from other instances of that same type of data object. An example of a legal entity instance would be the modeling of “Midwest Regional Distribution Center” as distinct from “Southeastern Regional Distribution Center.” Relationships describe how data elements are related to one another, and what types of relationships (one-to-one, one-to-many, uniqueness) are allowed in the system. Dimensions are used to organize and present data in the user interface, usually on a drop-down list at the top of the detail screens. An example of dimensions includes scenario years, which are “buckets” into which many other data elements fall. Some elements, such as jurisdictions, act as dimensions on other screens.

A tax modeling exercise begins with “last filed” data from the most recently completed tax year as the starting year of the scenario. The Federal data in the scenario models comes from the Federal Consolidated Tax Form 1120 filed for the entire corporation, individual Federal 1120 forms for each legal entity in the corporation, Federal income data, which is either line 28, line 30, or line 28 minus line 29a on the Federal tax form 1120, for state taxes, other state data obtained from state income tax filings or from internal accounting records for sub-entity data.

A scenario is the focal point of the data model. A scenario is the complete set of data used for a given tax model calculation. It contains all other data elements (except reports). Each scenario is associated with one or more years representing a contiguous time period.

The model includes accounts that are the set of line items representing items such as income statements, tax schedules and apportionment factors. Account data may be entered, user-supplied, or calculated by the system from other input data

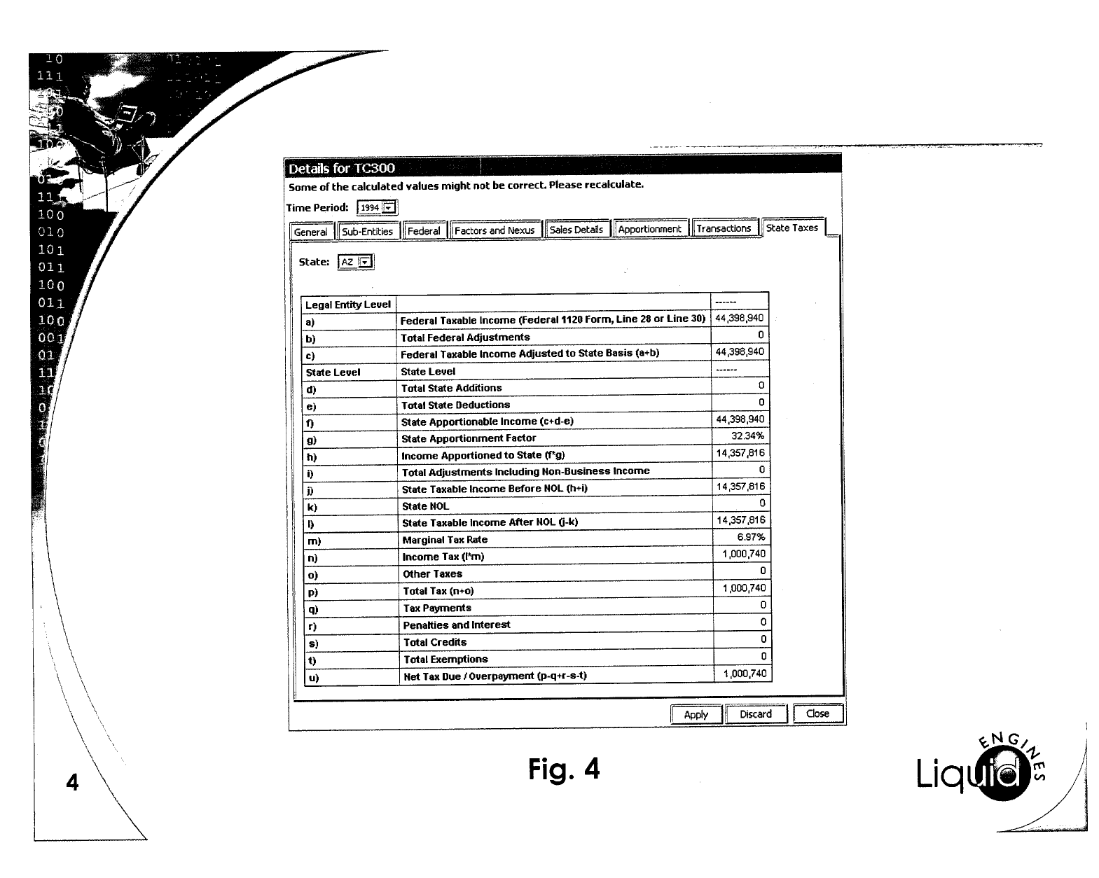

The model includes a legal entity that represents the lowest level of corporate state taxation (but not the lowest level of data granularity). FIG. 4 illustrates a screen shot of a legal entity detail. A legal entity can be a single-location operation or a multi-state enterprise with numerous distribution centers, operations or divisions, branch offices, or other entity definitions or properties. Entities marked as “foreign” are considered non-taxable, but are included in all group calculations when the group's filing position is “Worldwide”.

Sub-entities allow maintenance of separate apportionment and income data for internal groups or divisions, at a level below that of the legal entity that files the tax returns. The sub-entity structure captures data representing one or more operations (single-site locations). An example of a sub-entity would be an organization such as marketing, sales, or customer support that maintains one or more separate offices or facilities.

The model includes jurisdictions that represent a tax authority other than the U.S. Federal government. Users can create and manage custom jurisdictions.

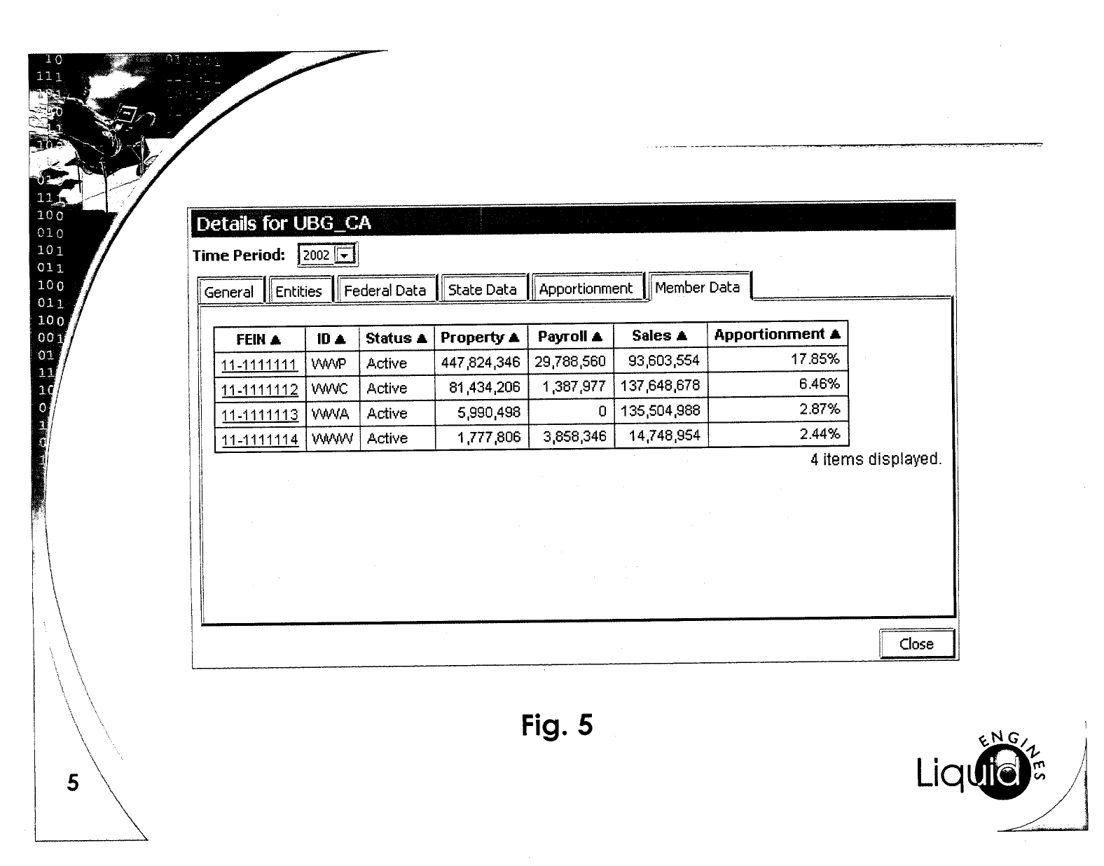

The model includes two kinds of filing groups: unitary business groups (UBGs) and consolidated filing groups (CFGs). FIG. 5 illustrates a partial UBG input page that is also representative of the CFG input page. Although each state has its own rules and guidelines for group filings, the modeling for each type of filing group is very similar. To illustrate, if a legal entity has nexus in a particular state, but that legal entity is not a member of any groups within that state, the legal entity is treated as filing a separate return for that state. The system allows the addition of legal entities to unitary groups. A legal entity can be in a unitary group regardless of whether the entity itself has nexus and/or factors in the state in which the unitary return is filed. In a preferred embodiment, a legal entity can only belong to one active group (either unitary OR consolidated) within a particular state. Sub-entities and operations do not have separate group membership. Only legal entities can be added or removed as members of a filing group. The membership rules and data attributes for consolidated filing groups are identical to those for unitary groups with the following exceptions: a legal entity may be a member of a consolidated group associated with a particular state only if the entity has nexus and/or factors within that state; there is no “waters edge” or “worldwide” filing position associated with a consolidated group as there is with a unitary group; a legal entity can only belong to one active group (either unitary or consolidated) within a particular state. Normally, eliminations occur between legal entities that do business with each other AND are members of the same filing group. The reported income (seller) and expense (buyer) line items for these entities are eliminated from tax calculations, and the sales factors are eliminated from apportionment calculations. An inter-company transaction represents the sale of goods or services between two legal entities (collectively referred to as an elimination entity) that affects the income, expenses, and apportionment factors for the seller and buyer. Each inter-company transaction is associated with a user-defined transaction type. Transaction types are used to manage common characteristics across similar inter-company transactions. Inter-company transactions inherit the pricing characteristics of the associated transaction type. By associating all similar inter-company transactions with a common transaction type, the model can respond to questions such as “What is the tax liability impact of changing the discount for all bulk sales from 10% to 12%?” by merely changing the discount percentage associated with the transaction type “Bulk Sales.” A range specifying the lowest and highest allowable discount/markup percentages, for use during optimization when suggesting optimal pricing for transactions of this type. Each tax rule listing in the model contains a complete set of tax rates, together with tax brackets and apportionment-related rules. There is a unique one-to-one relationship between a tax rule and a state. This means that even if two states both have a tax rule called “Tax Rule 1”, these rules are not the same instance; the “Tax Rule 1” that is associated with State 1 is completely distinct from the “Tax Rule 1” that is associated with State 2.

Each scenario represents a complete set of tax plans for a corporation, including legal entity structures, jurisdictions, tax rates, and tax return information. A scenario can span across any contiguous period of time.

Whenever a change to a detail screen is made and the Apply button is selected, the changes are written to the database, but dependent values are unchanged. The scenario is not recalculated until the Calculate button at the top of the screen is selected. For the sake of efficiency, the system calculates only those portions of the model that are actually affected by user changes. When the user makes changes, the system tracks user changes and marks the affected objects as changed. For example, changing a state form for a legal entity will cause that particular legal entity to be marked as “dirty” (needing recalculation). All related objects, such as any groups that the legal entity might belong to, are also marked as needing recalculation.

Some GUI operations such as the update of inter-company transactions or an update to a transaction type, also cause any related data elements to be marked as needing recalculation.

When the user clicks the Calculate button, the system looks for these objects that were previously marked as needing recalculation, and recalculates only those objects. This saves time; for example, a scenario with hundreds of legal entities might only need one or two of those entities recalculated for a minor change.

The system enables flexible treatment of a legal entity, which represents business organization that is legally responsible for paying taxes. A legal entity may be partially or wholly owned subsidiary of a larger corporation. Legal entities may be treated as separately taxed entities, or they may be grouped for combined tax returns. A sub-entity represents a portion of a parent legal entity that has been “carved out” for modeling purposes. For example, it may be desirable to model a sales division separately, in order to determine whether that division should be moved under a different parent entity, or perhaps made into its own legal entity for tax purposes.

The model requires that each legal entity include whether it has factors and nexus for each jurisdiction within the scenario. If the entity has nexus within a jurisdiction, it must have a tax rule selected from the tax rules associated with that jurisdiction.

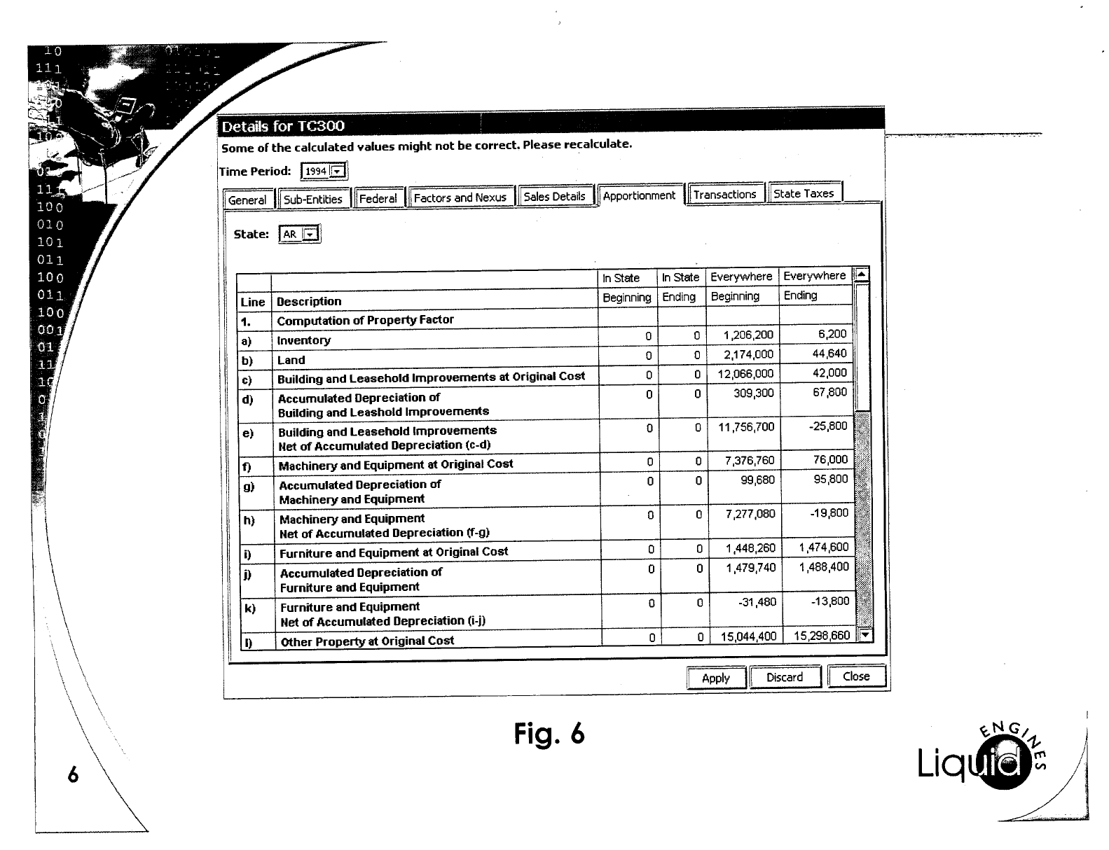

The model includes apportionment percentages by state and by year such as is illustrated in the screen shot of FIG. 6. The data is system-calculated during each scenario calculate, and is not editable. If the legal entity is filing separately in the selected state, then in-state numbers are editable. The everywhere numbers are calculated by the system based on the apportionment rules (factors used in that state) in the tax rule associated with the legal entity for the selected state. A “Sales Details” tab information (not shown) supplies the information for destination and throwback sales, which are not editable on the “Apportionment” tab.

State tax data for a legal entity is partially calculated by the system and partially supplied by the user. The model permits adjustments to the Federal income statement. The adjustment fields may or may not be editable, depending on the legal entity's group membership within a state: If the legal entity is filing separately in that state, then the adjustments fields are editable. If the legal entity is filing as part of a unitary business group or consolidated filing group in that state, then these fields are not editable on the legal entity's individual form, but instead would be edited on the group's version of this form.

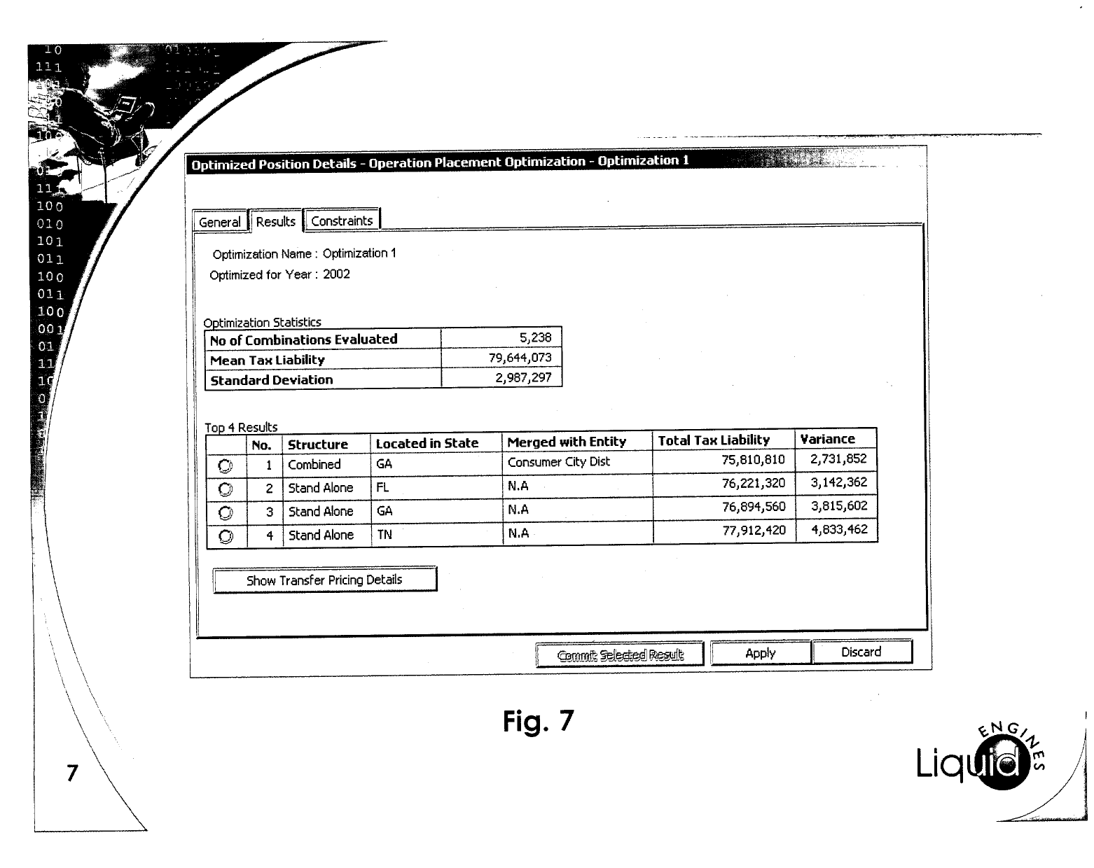

The model includes a function to create unique operations in order to test entity restructuring based on a temporarily modeled single-site operation such as a plant or distribution center. The system can also model multi-site operations. FIG. 7 illustrates a screen image showing the setup for a what-if scenario for a new distribution center. For example, a company may be considering the purchase of a new building in one of three possible states and it is desirable to identify which state would result in the most advantageous overall tax position. To do this, the operation is created and then run an optimizer wizard is executed to compare various combinations of location and entity structuring options. The optimizer also includes options for whether to merge the operation with an existing legal entity, or whether to create a new standalone legal entity for the operation, and how to apply factors and nexus. After reviewing optimizer results, one of the solutions presented by the optimizer can be selected and implement it in the model. In either case, the operation becomes a sub-entity under a parent legal entity when a solution is chosen as a permanent part of the model. Advantageously, the operation's data does not affect tax calculations until the operation has been placed and converted into a legal entity or sub-entity.

An operation has most of the properties of a legal entity except for state data (tax form, factors, and nexus). The information that an operation does contain includes a name, business activity, entity type, domestic/foreign characteristic, as well as tabs for a Federal Data form, Apportionment, Sales Details, and inter-company Transactions.

Differences in the forms between legal entities and operations are as follows:

An operation does not have a State Form tab, because it does not have nexus.

On the Apportionment Data tab, there is no “Everywhere” column (only “In-state”), because the operation, once placed, will exist in a single state only.

An operation can have inter-company transactions with other legal entities or sub-entities, but not other operations. State information is left as “TBD” (to be determined).

The transactions will be applied to the legal entities involved only after the operation has been integrated into a legal entity.

The model allows the transfer a sub-entity from one parent to another to model various restructuring alternatives. A wizard is provided that allows the user to manually specify whether to transfer the nexus information from the old parent to the new one. If a newly created sub-entity is the first sub-entity under a previously childless parent, the system transfers all the Federal, apportionment, sales details, and state tax data from the parent to the sub-entity. The parent entity forms are zeroed out and become non-editable. When the scenario is calculated, the values from the sub-entity will be rolled back up to the parent as view-only data.

When the first sub-entity is created under a previously childless parent entity, any inter-company transactions that were previously associated with the parent move down to the sub-entity level, and are associated with the new sub-entity. All future inter-company transactions must then be created at the sub-entity level. Inter-company transactions between two sub-entities with the same parent can be created but are not applied. If one of those sub-entities is transferred to a different parent, the transaction is applied at that time.

Legal entities may be grouped for taxation purposes. There are two kinds of groupings: unitary business groups and consolidated business groups and consolidated filing groups. Because of the differences in how each state recognizes or regulates group filings, it is up to the user to determine which group type to use within a particular state.

A unitary filing group is associated with one particular jurisdiction, and does not require that all entities have either factors or nexus in the filing state. A filing group can be set to active or inactive. This allows the rapid evaluation of the difference a group filing can make, without having to undo all the membership associations. By default, new groups are created with a status of “active.”

An entity can only belong to one active group—of either type—within the same state. If a group is inactive members can belong to another active group within that state and all of its members that are not in another active group within that state are treated as filing separate returns. If members are attempted to be added to an active group, or try to activate a previously inactive group, the system checks at that point whether there are any concurrent members in other active groups within that same state.

Each filing group has an associated tax rule applied at the group level that can be any tax rule from the tax rules associated with the group's filing state. This tax rule can be different from the tax rules associated with each of the member entities. Jurisdictions represent geographical areas associated with a particular taxation authority. Jurisdictions exist within a particular scenario. However, jurisdictions can be copied from one scenario to another. Pre-configured jurisdictions, also known as system-defined jurisdictions, are jurisdiction definitions and tax rules that are shipped with the system. These jurisdictions cannot be deleted or modified; however, it is possible to duplicate them and modify the duplicates. When a new user-defined jurisdiction is created (as opposed to duplicating a system-defined one), the system automatically assigns it a copy of the default system-defined tax rules.

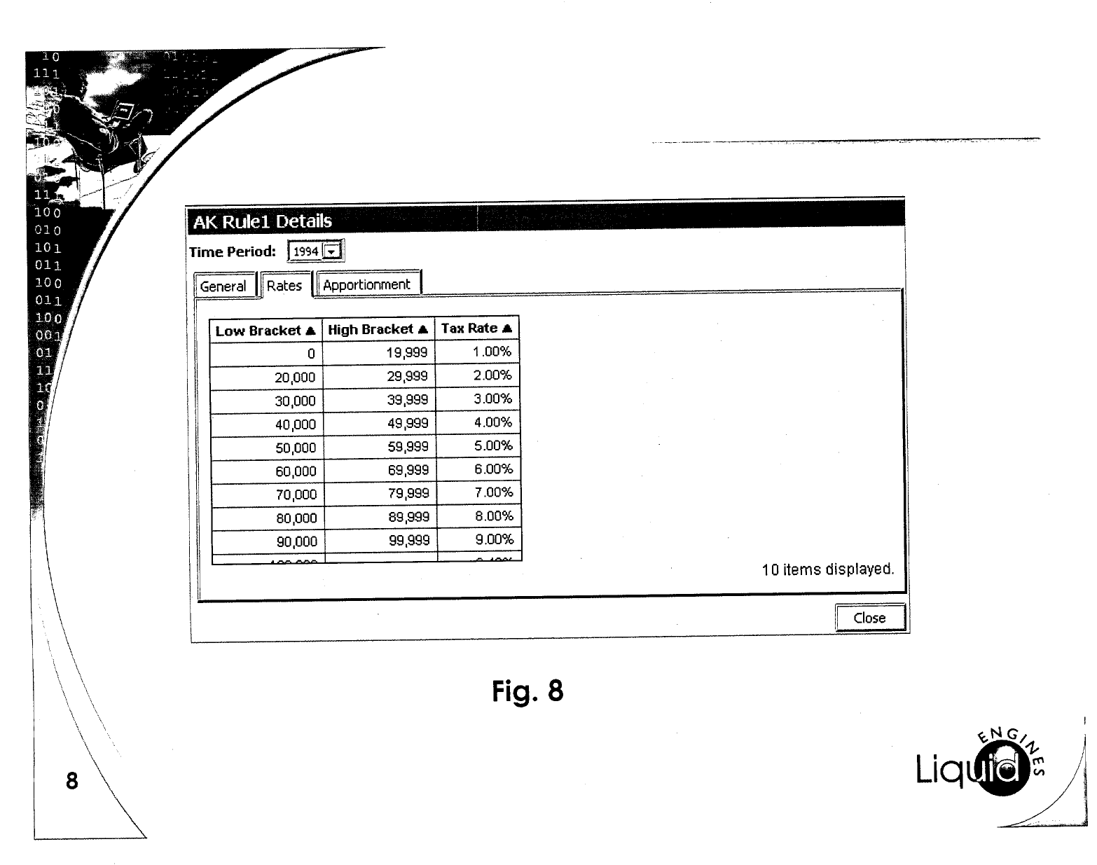

The model has at least one jurisdiction associated with one tax rule defined in a scenario in order to build a meaningful model such as illustrated in FIG. 8. Although it is possible to create scenarios that use only the system-defined jurisdictions and tax rules, it is expected that users will want to modify the tax rules associated with particular jurisdictions. After modeling any additional tax rules that are needed, the factors and nexus for legal entities must be set and the appropriate tax rules that should apply to each entity selected.

The model includes lists of all tax rules associated with the selected jurisdiction. The model enforces that each jurisdiction in a scenario has at least one set of tax rules associated with it. New tax rules can be added by creating them from scratch or by duplicating an existing set (already associated with the jurisdiction).

Each “tax rule” instance represents a set of tax rates and apportionment rules to apply to a legal entity or filing group. Each jurisdiction is associated with one or more sets of tax rules. Each set of tax rules is associated with one and only one jurisdiction within a particular scenario.

The model permits customization of apportionment factors, apportionment factor weights and whether a state uses sales throwback. Apportionment is the process of calculating the percentage of an entity's total reported income that is taxable within a particular state. This is done by assessing the proportions of property, sales, and payroll values for that entity within the state vs. “everywhere” (sum of these numbers across all states where this entity does business). Each state may have different rules for calculating apportionment. Apportionment factors are associated with tax rules. Each tax rule in turn is associated with exactly one state or user-defined jurisdiction. Apportionment amounts are entered for each legal entity, for each state where that legal entity has nexus or factors, by scenario year.

The system enables planners to generate accurate scenarios in minutes. Powerful entity structuring and inter-company transactions wizards save planners long hours by rapidly modeling structure changes, automatically moving inter-company relationships, and recalculating tax data. Further, the system utilizes active/inactive flags that allow planners to instantly model the presence/absence of entities, groups, factors and jurisdictions. The system also allows planners to create custom structures to model special circumstances such as negotiated tax positions, or extend the system to include special types of taxes.

Wizards assist users in modeling some complex tax planning activities, such as combining or splitting entities, moving factors between entities or states, or optimizing transfer pricing based on existing inter-company transactions. Several modeling features are available as wizards or as optimizers. The difference between a wizard and an optimizer is that with a wizard, a user may model a particular configuration and the wizard is responsible for stepping through the process. With an optimizer, the user enters constraints and the system tests all possible combinations within those constraints to find the best configurations where “best” means “minimum tax liability.” The system displays a user-specified number of top results except an additional step is required to select a particular result and commit it in the scenario.

Wizards and optimizers for splitting entities and moving factors across entities or states have a series of screens that ask you to assess property, payroll, and sales factor amounts, as well as specifying portions of sales details and Federal data.

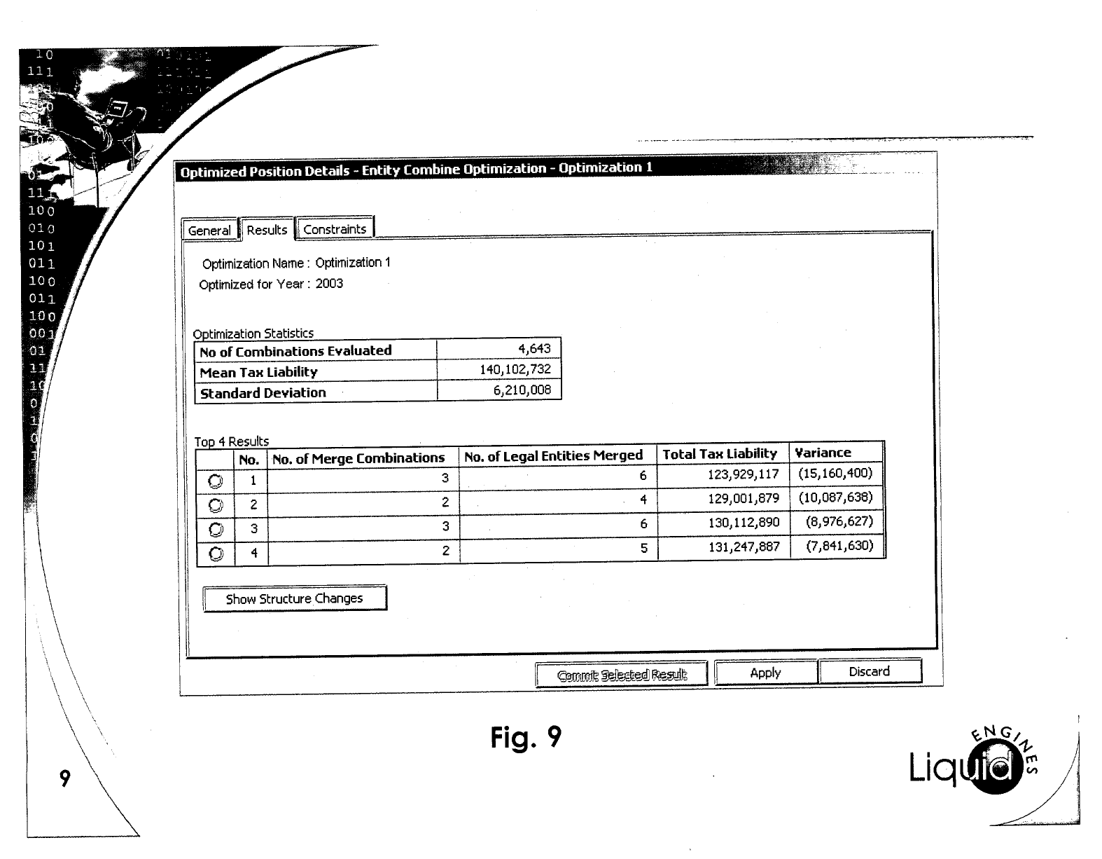

The model stores the results of all optimizations under a series of analysis screens such as is illustrated in FIG. 9. These screens are similar to the Summary and Detail screens for other data elements such as legal entities, jurisdictions, or filing groups. The results for each type of optimization are stored under a “Summary” screen, which is available from the treeview, with line items leading to tabbed detail screens for each result.

The model includes an Entity Combine function that allows a user to quickly model the effect of combining two legal entities into a single entity known as the combined entity. In this process, the system does the following:

Creates a new legal entity instance that has the same name and FEIN number as one of the original entities. The original entity whose FEIN number is reused is called the surviving entity, and the other is called the liquidating entity.

The system creates two sub-entities under the surviving entity and moves the data from the original entities into these sub-entities.

Both original entities are listed on the GUI screens as “inactive” after the specified entity combine year.

The liquidating entity remains in the scenario, and remains active up until the combine date, after which it becomes inactive.

The optimizer searches for possible entity combinations from a range of selected legal entities. The results are presented, and the user has the option of committing those results or discarding them. The resulting legal entity structures in the scenario are not changed unless results are committed.

The model includes a Move Factors feature that allows portions of a legal entity's factors to be moved from one state to another, or from one sub-entity to another. A Move Factors Across Jurisdictions wizard allows the model to show the effects of moving some portion of the factors of a legal entity or sub-entity from one jurisdiction to another within that same entity.

The model includes an Entity Split feature that allows portions of legal entities or sub-entities to be carved out to facilitate restructuring. The model uses a Sub-Entity Split Wizard to break apart a selected sub-entity into two sub-entities under the same parent and then uses an Entity Split Optimizer to examine a selected set of entities with sub-entities, and identify possible opportunities by moving the sub-entities from one parent to another or making selected sub-entities into standalone legal entities.

The model includes an operation that enables the representation of a single-location operation such as a manufacturing plant or customer service center and allows the user to determine the most tax-advantageous combination of legal entity structure and state location for a previously defined operation.

During the optimization operation the model performs the logical processing considering the following data when applying the business logic pre-processing:

Information from the operation to be placed:

Line 28 from Form 1120 for the operation;

Apportionment factor numerators and denominators for all possible state locations;

Information from the Sales Details tab for the operation.

Information on all possible entities where this operation could be located:

Apportions income line items from state forms for all entities filing separate returns;

Apportionment factor numerators and denominators for all entities filing separate returns;

Throwback sales ship from/ship to details;

Information for all active groups:

Apportions income from state form;

Factor numerators and denominators;

Throwback sales ship from/ship to details.

Data for all inter-company transactions where the operation is either a source or a destination:

Income/expense line item impacts for seller and buyer, respectively;

Factor impact to buyer and seller, by state.

State tax rules for each state selected as a potential location for the operation.

The model also includes a transfer pricing optimizer that is available through the user interface along with the other optimizers.

The system includes the features for data viewing and comparison. These features include a set of predefined reports and a report wizard for designing custom reports; a summary-level view of scenario data; and a set of editable view screens that provide a summary-type layout for data entry across multiple entities or years. Reports are detailed snap-shots of scenarios that are presented in a Microsoft Excel pivot table interface. Reports are the only objects that exist independently of a scenario. There are predefined system reports, as well as custom user-defined reports. Reports provide the user a variety of views regarding the entity. For example, one view shows, at the legal entity level, taxable income, apportionment, and estimated income—by jurisdiction. Another view shows, at the group level, taxable income, apportionment, and estimated income tax. Another view compares multiple scenarios across multiple time periods based on key metrics such as overall tax liability, apportionment percentages and tax liability in various states.

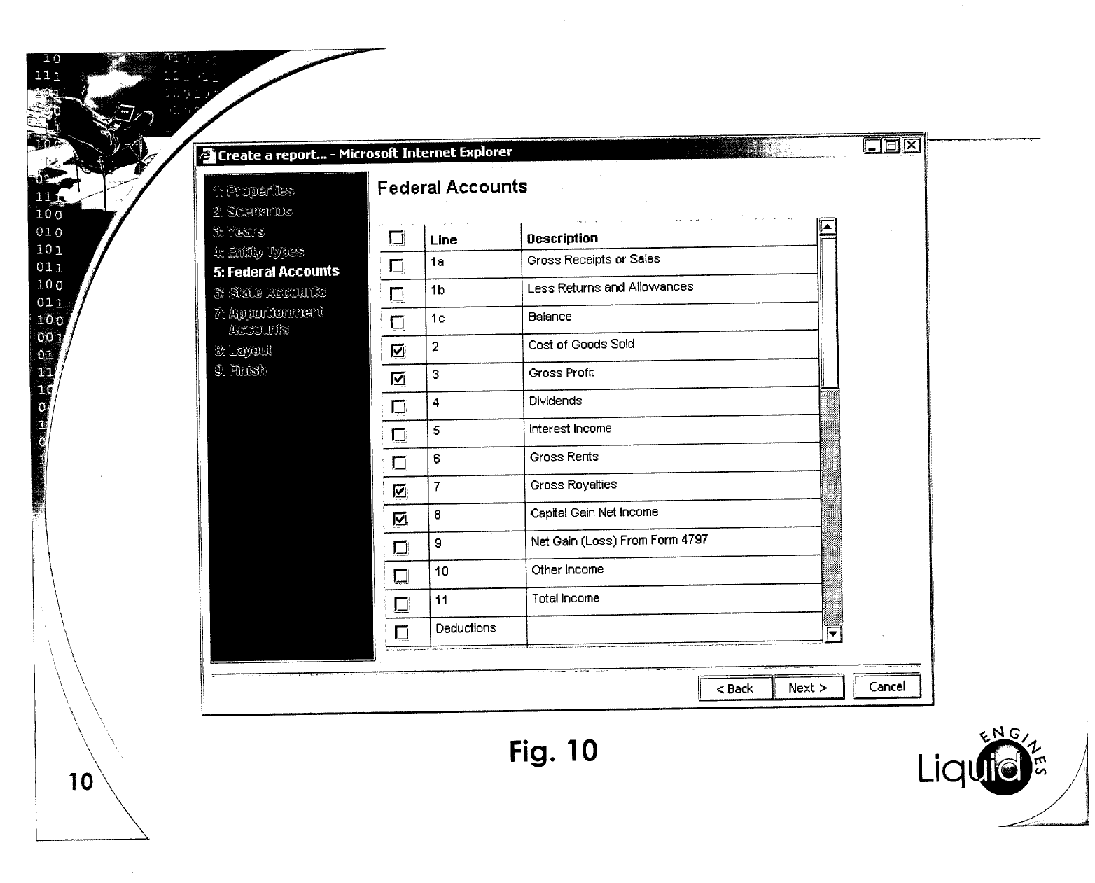

Reports also provide summary statistics that show, for the scenario, the number of legal entities, separate filings, unitary filings, consolidated filings, and summary tax liability. Other views are readily envisioned by those skilled in the art. FIG. 10 illustrates a screen shot of a report wizard. With a wizard a user can model a particular configuration and use the wizard to step through the process and generates the report. In comparison, with an optimizer, a user enters constraints and the system tests all possible combinations within those constraints to find the best configurations. In the case of evaluating tax consequences of a business decision, “best” means “minimum tax liability.” The system displays a user-specified number of top results.

While certain exemplary preferred embodiments have been described and shown in the accompanying drawings, it is to be understood that such embodiments are merely illustrative of and not restrictive on the broad invention. Further, it is to be understood that this invention shall not be limited to the specific construction and arrangements shown and described since various modifications or changes may occur to those of ordinary skill in the art without departing from the spirit and scope of the invention as claimed. For example, although the invention has been discussed in connection with tax optimization, aspects of the invention can be applied to optimization of other parameters such as maximizing revenue, regulating inventory, etc. The invention can be adapted for use with any number and type of factors that influence the outcome of an optimization. Varying degrees of optimization, or other processing of the invention can be manual or automatic. Where automated, any combination of hardware and/or software can be used to perform any of the functions described herein.

Other embodiments of the invention can use different terminology, models, structure and approaches from those described herein. For example, the approach of entities, organizations, active groups, etc., need not strictly be used. Other concepts, nomenclature and terminology can be employed. In some embodiments it may be desirable to have entities defined in other ways than commercial legal concepts, such as geographically, temporally, or according to administrative, governmental or other jurisdictional rules.

Note any of the functions, method steps or processes of the invention can be performed by one or more hardware or software devices, processes or other entities. These entities can reside in the same location or can reside remotely as, for example, entities interconnected by a digital network such as the Internet, a local area network (LAN), campus or home network, standalone system, etc. Although functions may have been described as occurring simultaneously, immediately or sequentially, other embodiments may perform the functions, steps or processes in a different order, or at substantially different times with respect to execution of other functions, steps or processes.

What is claimed is:

1. A method for assigning a financial factor to one of a plurality of business entities, the method comprising
identifying a factor to be assigned;
indicating a metric to be optimized;
defining one or more rules to be used in a matching process;
using a computer system to perform a step of comparing degrees of optimization of the metric based on assignment of the factor to different ones of the plurality of business entities, wherein the one or more rules are used to derive the degrees of optimization; and
using the result of the comparing step to assign the financial factor to the one of a plurality of business entities.

2. The method of claim 1, wherein the factor includes cost.

3. The method of claim 1, wherein the factor includes revenue.

4. The method of claim 1, wherein the factor includes product shipping allocation.

5. The method of claim 1, wherein the factor includes sales allocation.

6. The method of claim 1, wherein the business entities are located in different geographic regions.

7. The method of claim 1, wherein the business entities are located in regions with different commercial laws.

8. The method of claim 1, wherein the metric includes growth.

9. The method of claim 1, wherein the metric includes profitability.

10. The method of claim 1, wherein the metric includes tax liability.

11. The method of claim 1, wherein the metric includes risk associated with changes to business allocations among a plurality of entities.

12. The method of claim 1, wherein the metric includes human incentives.

13. The method of claim 1, wherein the step of comparing degrees of optimization uses a matching engine as described herein.

14. The method of claim 1, wherein the step to create complete and stable planning models using only essential data elements.

15. A method for analyzing a business operation, the method comprising
using a computer system to provide projected tax liability when costs and revenue are allocated among a plurality of business entities, wherein the computer system executes a matching engine using weighting of attribute values.

16. The method of claim 15, wherein the computer system uses discrete weighting.

17. The method of claim 15, wherein the computer system uses continuous weighting.

18. The method of claim 15, wherein the computer system uses substitution of variables.

19. A method for analyzing a business operation, the method comprising
allocating one of cost or revenue among a plurality of business entities;
using a computer system to provide projected tax liability based on the allocations made in the step of allocating; and
using the computer system to provide incentive determination based on the allocations made in the step of allocating.

20. The method of claim 19 further comprising using the computer system to access a cost allocation module; a transfer pricing module; an income shifting module; a capital investment module; and a financing module.

21. The method of claim 19 further comprising the defining a base case having a first set of either cost or revenue allocations and performing a series of iterations to define a plurality of “what if” cases based on at least a second set of either cost or revenue allocations.

22. A method for analyzing a business operation, the method comprising
allocating one of cost or revenue among a plurality of business entities;
using a computer system to provide projected tax liability based on the allocations made in the step of allocating;
using the computer system to provide an risk assessment projection based on the allocations made in the step of allocating.

23. A method for optimizing taxes for a multi-jurisdiction entity, the method comprising:
defining a plurality of case, including at least one base case;
defining said entity in terms of at least one location, the number of subsidiary entities and the relationship between each such subsidiary entities;
using a computer system to perform an optimization process based on at least one model, said model having a plurality of rules for deriving tax implications of business operation, and the defined entity;
using the computer system to allocate financial metrics.

24. The method of claim 23 further comprising generating a report, said report including a comparison of the allocation of financial metrics for the base case and at least one other case based on a different allocation of financial metrics.

25. The method of claim 24 further comprising exporting the report to a data management application to enable a user to drill down to data supporting said report.

26. The method of claim 23 further comprising generating a “what-if” case using a wizard to reassign the financial metrics of a parent to a sub-entity.

27. A system for providing strategic business units, finance, treasury, and tax departments in a global company visibility on its forecasted cash flow, including forecasted revenues, forecasted expense and forecasted capital decisions, where said business units are located in a plurality of jurisdictions such that said cash flow is allocated to selected ones of said strategic business units in view of the tax laws for each jurisdiction and generally accepted accounting principles (GAAP), said system comprising:
Means for defining a plurality of scenario-based approaches that allows multi-year tax planning and analysis across said business units and for sharing the results between users; and
Means for disseminating said scenario-based approaches to each of said business units.

28. The system of claim 27 wherein said disseminating means further includes a server and a plurality of web-based browsers, coupled to said server, so that said defining means accepts factors from each of said strategic business units.

29. The system of claim 28 further comprising an optimizing function for splitting an entity into a plurality of entities in different jurisdictions to modify a selected one of said scenario-based approaches.

30. The system of claim 28 further comprising an optimizing function for combining a plurality of entities located in a plurality of entities in different jurisdictions to a common entity to modify a selected one of said scenario-based approaches.

31. The system of claim 28 further comprising an optimizing function for creating a new entity to modify a selected one of said scenario-based approaches.

32. The system of claim 28 further comprising an optimizing function to optimize the transfer pricing to modify a selected one of said scenario-based approaches.

33. The system of claim 28 further comprising an optimizing function for splitting an entity into a plurality of entities in different jurisdictions to modify a selected one of said scenario-based approaches.

34. The system of claim 28 further comprising a plurality of optimizing functions to modify a selected one of said scenario-based approaches.

35. The system of claim 28 further comprising:
An allocation engine;
An analysis engine; and
Means for defining the relationship between each of said strategic business units.
